(19) United States
(12) Patent Application Publication
(10) Pub. No.: US 2026/0152644 A1
(43) Pub. Date: Jun. 4, 2026

(54) ANTI-FOULING COATING SOLUTION AND METHOD OF MANUFACTURING SAME

(71) Applicants: SAMSUNG ELECTRONICS CO., LTD., Suwon-si (KR); KOREA UNIVERSITY RESEARCH AND BUSINESS FOUNDATION, Seoul (KR)

(72) Inventors: Kihun JEONG, Suwon-si (KR); Bitgaram KIM, Seoul (KR); Jihun SEO, Seoul (KR); Youngdeog KOH, Suwon-si (KR); Kwangjoo KIM, Suwon-si (KR)

(73) Assignees: SAMSUNG ELECTRONICS CO., LTD., Suwon-si (KR); KOREA UNIVERSITY RESEARCH AND BUSINESS FOUNDATION, Seoul (KR)

(21) Appl. No.: 19/461,007

(22) Filed: Jan. 27, 2026

Related U.S. Application Data
(63) Continuation of application No. PCT/KR2024/095177, filed on Feb. 15, 2024.

(30) Foreign Application Priority Data
Sep. 6, 2023 (KR) 10-2023-0118659

(51) Int. Cl. C09D 5/16; C09D 7/20; C09D 175/04; C09D 175/06

(52) U.S. Cl. CPC C09D 5/1662; C09D 7/20; C09D 175/04; C09D 175/06

(57) ABSTRACT

One aspect of the present disclosure may provide a polyurethane-based coating material and a coating solution including the same, wherein the polyurethane-based coating material may ensure mechanical rigidity on the basis of a polyurethane material and may simultaneously induce super-hydro-repellent properties, and thereby may achieve antifouling and antibacterial properties. An anti-fouling coating solution may include a fluorine-containing polyurethane polymer (FPU), a fluorine-containing urethane monomer (FU), and polytetrafluoroethylene (PTFE).

### CROSS-REFERENCE TO RELATED APPLICATIONS

This is a continuation application, under 35 U.S.C. § 111 (a), of International Application No. PCT/KR2024/095177, filed Feb. 15, 2024, which claims priority under 35 U.S.C. § 119 to Korean Patent Application No. 10-2023-0118659, filed Sep. 6, 2023, in the Korean Intellectual Property Office, the disclosures of which are incorporated herein in their entireties by reference.

### TECHNICAL FIELD

The present disclosure relates to a polyurethane-based super-hydrophobic material containing a fluorine group, a coating solution containing the same, and a method of manufacturing the same, and more particularly, to an anti-fouling, antibacterial, or self-cleaning coating solution having super-hydrophobic properties.

### BACKGROUND ART

Super-hydrophobic materials with a water contact angle of 150 degrees or more are receiving great attention due to various functions, such as self-cleaning, anti-icing, oil-water separation, and anti-fouling.

### DISCLOSURE

### Technical Problem

An aspect of the present disclosure provides a polyurethane-based coating material and a coating solution including the same, which are capable of securing mechanical strength based on a polyurethane material and inducing super-hydrophobic properties to implement anti-fouling and antibacterial properties.

The technical objectives of the present invention are not limited to the above, and other objectives that are not described above will be clearly understood by those skilled in the art from the above detailed description.

### Technical Solution

In accordance with the present disclosure, anti-fouling coating solution may include:
a fluorine-containing polyurethane polymer (FPU), a fluorine-containing urethane monomer (FU), and polytetrafluoroethylene (PTFE),
wherein the FPU may include:
a volatile solvent,
a fluorinated alcohol represented by CₐH₂F₂ₐ₋₁OH (with a being a natural number of 10 or less) and containing a hydroxyl group bonded to an end,
a fluorinated diol represented by C_{b}H₄F_{2b-4}(OH)₂ (with b being a natural number of 20 or less) and containing hydroxyl groups respectively bonded to both ends,
an alcohol containing two or more hydroxyl groups, and
a first isocyanate crosslinking agent containing two or more isocyanate groups,
a ratio of a molar weight of the fluorinated diol of the FPU to a molar weight of the FPU may range from 0.7 to 0.9,
a ratio of a sum of the number of hydroxyl groups contained in the fluorinated alcohol, the fluorinated diol, and the alcohol to the number of isocyanate groups contained in the isocyanate crosslinking agent may be 1:1, and
the FU may include:
a fluorinated alcohol represented by C_{c}H₂F_{2c-1}OH (with c being a natural number of 10 or less) and having a hydroxyl group bonded to an end, and
a second isocyanate crosslinking agent containing two or more isocyanate groups.

Also, in accordance with the present disclosure, a method of manufacturing an anti-fouling coating solution may include:
producing a fluorine-containing polyurethane polymer (FPU) by:
mixing a volatile solvent, a fluorinated alcohol represented by CₐH₂F₂ₐ₋₁OH (with a being a natural number of 10 or less) and containing a hydroxyl group bonded to an end, a fluorinated diol represented by C_{b}H₄F_{2b-4}(OH)₂ (with b being a natural number of 20 or less) and containing hydroxyl groups respectively bonded to both ends, an alcohol containing two or more hydroxyl groups, an isocyanate crosslinking agent including two or more isocyanate groups, and a catalyst to form a first solution,
mixing a volatile solvent and an isocyanate crosslinking agent containing two or more isocyanate groups to form a second solution,
mixing the second solution and the first solution at a temperature of 0° C. to 80° C. for 2 hours to 4 hours to form a third solution,
mixing a volatile solvent and a fluorinated alcohol represented by CₐH₂F₂ₐ₋₁OH (with a being a natural number of 10 or less) and having a hydroxyl group bonded to an end to form a fourth solution, and
mixing the fourth solution and the third solution at a temperature of 50° C. to 80° C. for 20 hours to 46 hours,
producing a fluorine-containing urethane monomer (FU) by:
pulverizing particles formed by stirring an isocyanate crosslinking agent including two or more isocyanate groups and a fluorinated alcohol represented by C_{c}H₂F_{2c-1}OH (with c being a natural number of 10 or less) and having a hydroxyl group bonded to one end for 30 minutes to 2 hours, and
mixing with the produced FPU, the produced FU and a polytetrafluoroethylene (PTFE) satisfying a weight ratio of 3 of the produced FU to 1 of the PTFE.

### Advantageous Effects

According to a concept of the disclosure, there are provided a polyurethane-based coating material and a coating solution including the same, which are capable of securing mechanical strength through a polyurethane-based material and inducing super-hydrophobic properties to implement anti-fouling and antibacterial properties.

### DESCRIPTION OF DRAWINGS

FIG. 1 shows FT-IR of FPU.

FIG. 2 shows FT-IR of FU.

FIG. 3 shows optimization of a water contact angle based on compositions of HFO.

FIG. 4A shows optimization of a water contact angle based on weights of particles.

FIG. 4B shows a contact surface with water after a coating solution according to the present disclosure is coated on a surface of a device.

FIG. 5 shows a water contact and friction test.

FIG. 6A shows SEM images according to presence/absence and compositions of particles containing fluorine groups.

FIG. 6B shows comparison of contact angles when FPU_{1PTFE-3FU} is dried at a room temperature or a high temperature of 70 degrees.

FIG. 7A shows changes in contact angle according to the numbers of tape peeling.

FIG. 7B is a SEM picture of a coating material surface after tape peeling is performed 10 times.

FIG. 8 shows results after a methylene blue anti-fouling test is performed 20 times.

FIG. 9 shows results of self-cleaning using SiC of dust series.

FIG. 10A shows SEM pictures after bacterial cells are applied on a super-hydrophobic material substrate and a bare substrate.

FIG. 10B shows the numbers of bacterial cells per area in a super-hydrophobic material substrate and a bare substrate.

### MODES OF THE INVENTION

Hereinafter, preferred embodiments of the present disclosure will be described. However, the embodiments of the present disclosure may be modified in various different forms, and the technical concept of the present disclosure is not limited to the embodiments which will be described below. Also, the embodiments of the present disclosure are provided to more completely describe the present disclosure for persons having ordinary skill in the related technical field.

The terms used in the present specification are merely used to describe specific embodiments. Therefore, an expression used in the singular encompasses the expression of the plural, unless it has a clearly different meaning in the context. In the present specification, it is to be understood that the terms such as “comprising”, “including” or “having”, etc., are intended to indicate the existence of the features, numbers, operations, components, parts, or combinations thereof disclosed in the specification, and are not intended to preclude the possibility that one or more other features, numbers, operations, components, parts, or combinations thereof may exist or may be added.

Meanwhile, unless otherwise defined, all terms used in this specification have the same meaning as those generally understood by those of ordinary skill in the technical field to which the present disclosure belongs. Accordingly, unless clearly defined in this application, they will not be understood as ideological or overly formal meanings. It is to be understood that the singular forms “a,” “an,” and “the” in this specification include plural referents unless the context clearly dictates otherwise.

As used in the specification, the terms “about”, “substantially”, or the like, which represents a degree, are used as meanings at numerical values or approaching the numerical values when inherent tolerances of preparation and material are presented to the abovementioned meanings, and they are used to prevent unconscientious invaders from unfairly using the contents in which accurate or absolute numerical values are disclosed in order to help the understandings of the disclosure.

Hereinafter, an anti-fouling coating solution will be described in detail with reference to the accompanying drawings.

Conventionally, super-hydrophobic properties are obtained by forming inorganic texture-based protrusions through various processes such as inorganic-based chemical vapor deposition or self-assembly, inspired by the micro-nano scale protrusions on the surfaces of lotus leaves.

However, in the case of such inorganic-based micro-nano scale protrusions, there is a fatal drawback that the structure is easily destroyed, which leads to deterioration of super-hydrophobic properties and limits applications as a practical coating material.

Meanwhile, polyurethane is synthesized through a condensation polymerization reaction of diisocyanate and diol.

Particularly, polyurethane is widely used in various fields due to excellent wear resistance and durability, and particularly, polyurethane provides various properties depending on internal functional groups of diisocyanate and diol used.

The present disclosure relates to a coating material and a coating solution that secure super-hydrophobic properties and have mechanical strength through a polymerization reaction using monomers containing a fluorine group and mixing with new organic molecules during polymerization of polyurethane.

Hereinafter, an embodiment of an anti-fouling coating solution will be described in detail with reference to the accompanying drawings.

The anti-fouling coating solution according to a disclosed embodiment may include a fluorine-containing polyurethane polymer (FPU), a fluorine-containing urethane monomer (FU), and polytetrafluoroethylene (PTFE), wherein the fluorine-containing polyurethane polymer (FPU) may include: a volatile solvent; a fluorinated alcohol represented by CₐH₂F₂ₐ₋₁OH (with a being a natural number of 10 or less) and having a hydroxyl group bonded to an end; a fluorinated diol represented by C₆H₄F_{2b-4}(OH)₂ (with b being a natural number of 20 or less) and having hydroxyl groups respectively bonded to both ends; an alcohol containing two or more hydroxyl groups; and an isocyanate crosslinking agent including two or more isocyanate groups, a molar weight ratio of the fluorinated diol to the fluorine-containing polyurethane polymer (FPU) may be between 0.7 and 0.9, a ratio of a sum of hydroxyl groups contained in the fluorinated alcohol, the fluorinated diol and the alcohol to the number of isocyanate groups contained in the isocyanate crosslinking agent may be 1:1, and the fluorine-containing urethane monomer (FU) may include: a fluorinated alcohol represented by C_{c}H₂F_{2c-1}OH (with c being a natural number of 10 or less) and having a hydroxyl group bonded to one end; and an isocyanate crosslinking agent including two or more isocyanate groups.

The fluorine-containing polyurethane polymer (FPU) may be polymerized through a urethane bonding formation reaction between a hydroxyl group at a molecular end and an isocyanate group existing in the isocyanate crosslinking agent, represented by chemical formulas 1, 2, and 3 below.

For example, when polymerization is performed by using hexamethylene diisocyanate (HDI) as the isocyanate crosslinking agent, a prepolymer represented by the following chemical formula 4 may be produced through a process represented by the following reaction formula 1, and then the polymerization reaction may be terminated by introducing the following chemical formula 1 (1,2,2,3,3,4,4,4-heptafluoro-1-butanol (1,2,2,3,3,4,4,4-Heptafluoro-1-butanol (HF))), thereby obtaining a molecular structure of a fluorine-containing polyurethane polymer (FPU) represented by the following chemical formula 5.

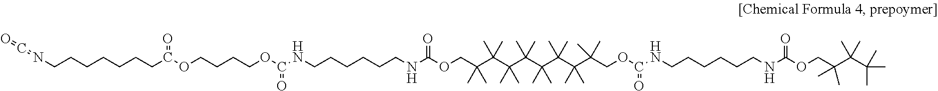 [SMILES: CC(C)(C)C(C)(C)C(C)(C)COC(=O)NCCCCCCNC(=O)OCC(C)(C)C(C)(C)C(C)(C)C(C)(C)C(C)(C)C(C)(C)C(C)(C)C(C)(C)COC(=O)NCCCCCCNC(=O)OCCCCOC(=O)CCCCCCCN=C=O]

(with n being a natural number)

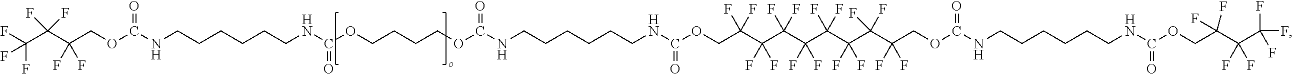

(with n being a natural number)

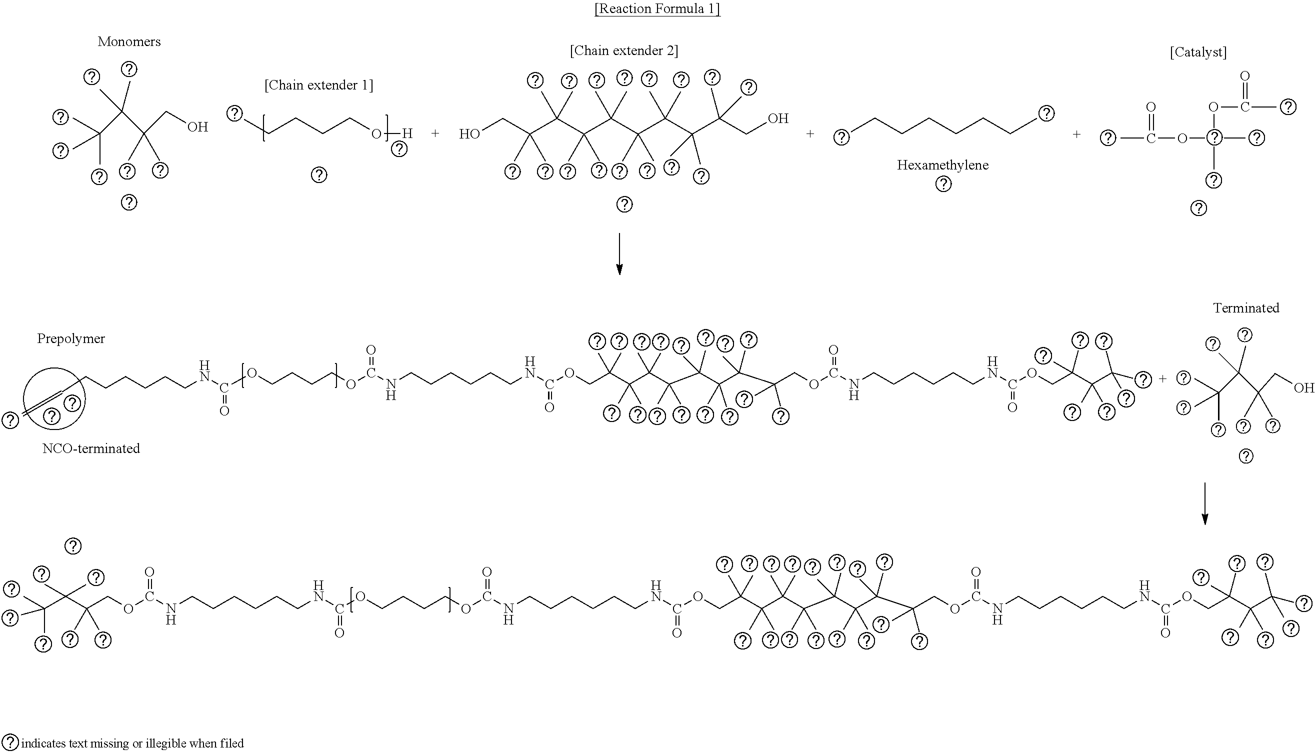

(with n being a natural number)

As another example, when polymerization is performed by using isocyanate as the isocyanate crosslinking agent, a prepolymer may be produced through a process represented by the following reaction formula 2, and then the polymerization reaction may be terminated by introducing the following chemical formula 1 (1,2,2,3,3,4,4,4-heptafluoro-1-butanol (1,2,2,3,3,4,4,4-Heptafluoro-1-butanol (HF))), thereby obtaining a molecular structure of a fluorine-containing polyurethane polymer (FPU).

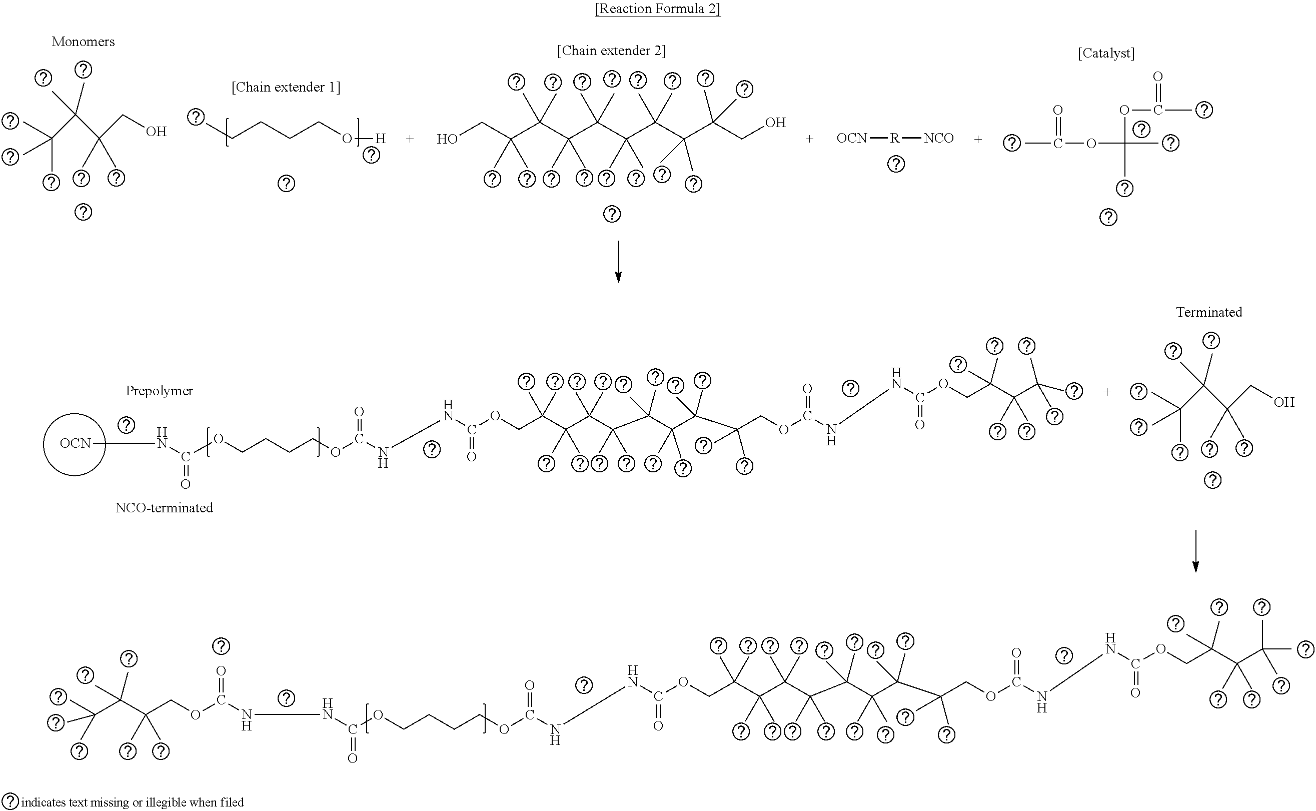

(with n being a natural number)

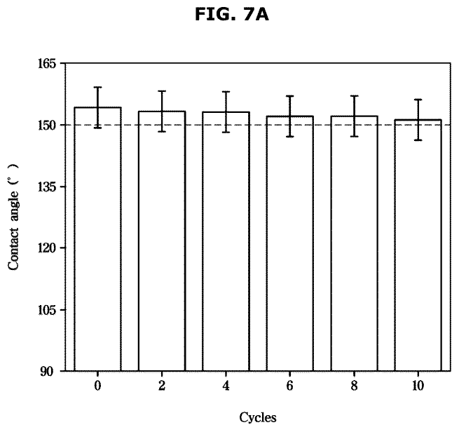

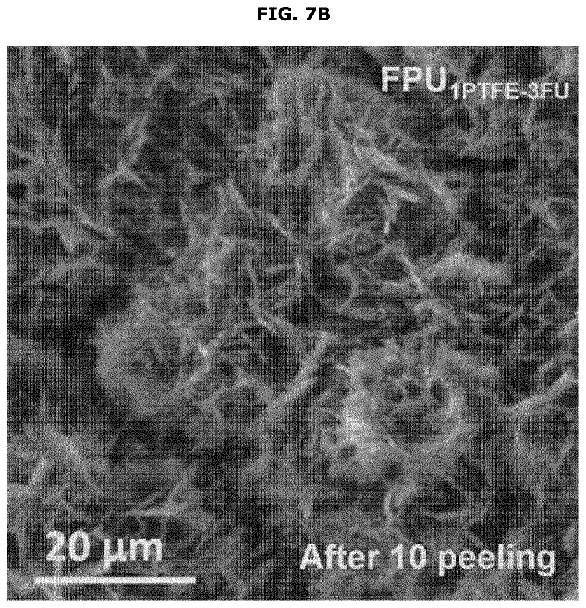

In the anti-fouling coating solution according to a disclosed embodiment, the volatile solvent may include acetone. Acetone has an advantage of not requiring heat during a coating process due to high volatility and is also a suitable solvent for polymerization of polyurethane. Particularly, it may be important that the anti-fouling coating solution according to the present disclosure exhibits water-repellent properties through formation of thorn-like morphology as shown in FIG. 7B. Acetone may form the thorn-like morphology through high volatility in the anti-fouling coating solution and thus may be suitable for securing water-repellent properties that the present disclosure requires.

In the anti-fouling coating solution according to a disclosed embodiment, a of the fluorinated alcohol contained in the fluorine-containing polyurethane polymer (FPU) may be 4, b of the fluorinated diol may be 10, and c of the fluorinated alcohol contained in the fluorine-containing urethane monomer (FU) may be 4. In a case where a of the fluorinated alcohol contained in the fluorine-containing polyurethane polymer (FPU) is 4, the fluorinated alcohol may have a structure represented by the following chemical formula 1.

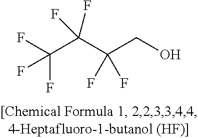 [SMILES: OCC(F)(F)C(F)(F)C(F)(F)F]

Also, in a case where b of the fluorinated diol is 10, the fluorinated diol may have a structure represented by the following chemical formula 2.

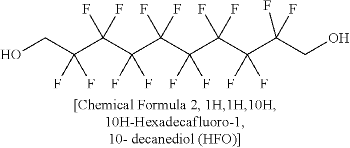 [SMILES: OCC(F)(F)C(F)(F)C(F)(F)C(F)(F)C(F)(F)C(F)(F)C(F)(F)C(F)(F)CO]

Also, in a case where c of the fluorinated alcohol contained in the fluorine-containing urethane monomer (FU) is 4, the fluorinated alcohol may have a structure represented by the following chemical formula 3.

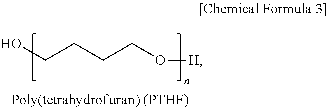

Here, n may be a natural number between 1 and 5000. A molar weight of Poly(tetrahydrofuran) (PTHF) corresponding to the chemical formula 3 may be about 2000 (Mn), but is not limited thereto.

In the anti-fouling coating solution according to a disclosed embodiment, the alcohol containing two or more hydroxyl groups may be one or more selected from a group consisting of the following compounds (n, m, a, and y are natural numbers),

Poly(tetrahydrofuran) (PTHF),

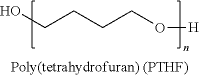

polycaprolactone diol,

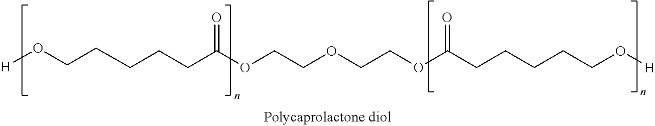

poly(hydroxybutyrate) diol,

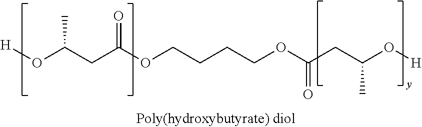

poly(lactide-co-caprolactone) diol,

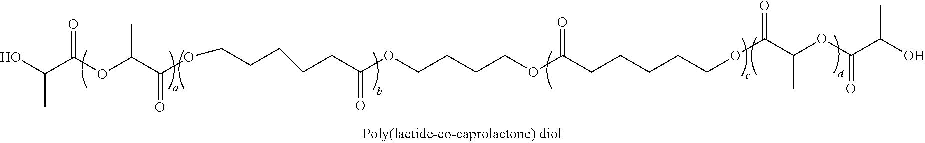

poly(ethylene glycol) diol,

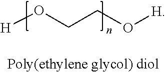

poly(ethylene terephthalate) diol,

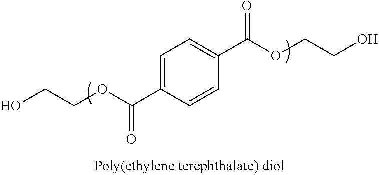

fatty acid-based linear diol,

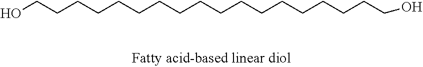 [SMILES: OCCCCCCCCCCCCCCCCCCO]

polylactide diol,

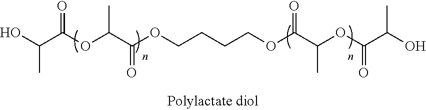

poly(butylene glycol) diol,

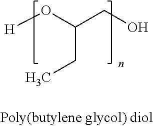

poly(propylene oxide) diol,

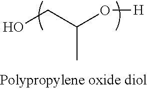

poly(tetramethylene oxide) diol,

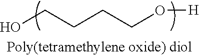

poly(ethylene adipate) diol,

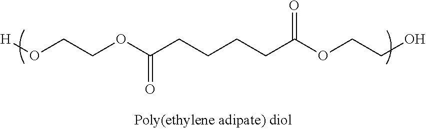

castor oil-based diol,

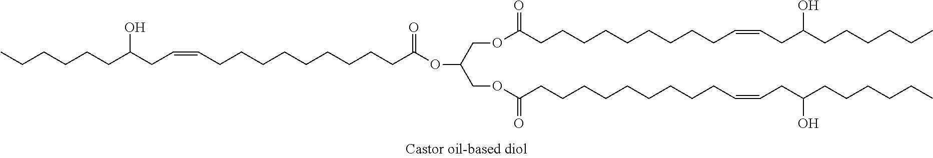 [SMILES: CCCCCCC(O)C/C=C\CCCCCCCCCC(=O)OCC(COC(=O)CCCCCCCCC/C=C\CC(O)CCCCCC)OC(=O)CCCCCCCCC/C=C\CC(O)CCCCCC]

polyglycolide diol,

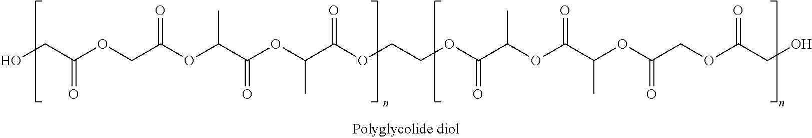

poly(lactide-b-glycolide) diol,

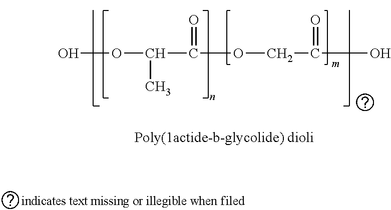

poly(hexamethylene carbonate) diol,

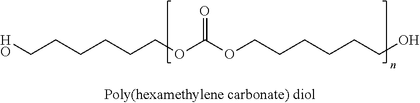

polycarbonate diol,

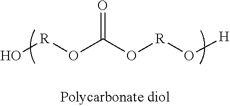

poly(buthylene adipate) diol, and

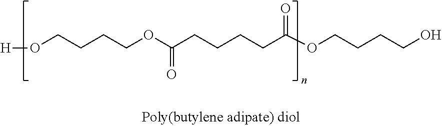

soybean oil-based diol

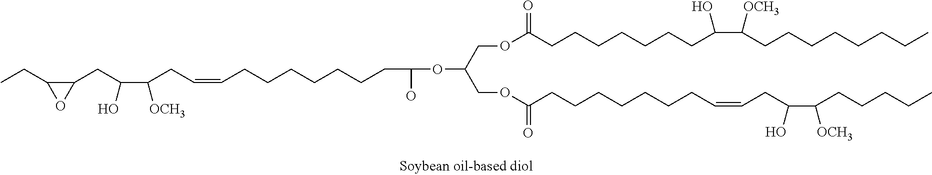 [SMILES: CCCCCCCCC(OC)C(O)CCCCCCCC(=O)OCC(COC(=O)CCCCCCC/C=C\CC(O)C(CCCCC)OC)OC(O)CCCCCCC/C=C\CC(OC)C(O)CC1OC1CC]

The alcohol containing two or more hydroxyl groups may have the structure described above, but is not necessarily limited thereto, and a polyfunctional alcohol containing two or more hydroxyl groups may be used without any special restrictions.

In the anti-fouling coating solution according to a disclosed embodiment, the isocyanate crosslinking agent may be one or more selected from a group consisting of hexamethylene diisocyanate (HIDI), diphenylmethane 4,4′-diisocyanate, 1,3-phenylene diisocyanate, isophorone diisocyanate, polyhexamethylene diisocyanate, triphenylmethan-4,4′,4″-triisocyanate, 1,3,5-triisocyanato-2-methylbenzene, and 1,3,5-triisocyanato-2,4,6-trimethylbenzene. However, the isocyanate crosslinking agent containing two or more isocyanate groups is not limited thereto, and any isocyanate crosslinking agent including two or more isocyanate groups may be used without any special restrictions.

In the anti-fouling coating solution according to a disclosed embodiment, the fluorine-containing polyurethane polymer (FPU) and the fluorine-containing urethane monomer (FU) may further include one or more catalysts selected from among dibutyltin dilaurate (DBTDL), dimethylaminopyridine (DMAP), triethylamine (TEA), diazabiclo[2,2,2]octane, and 1,4-diazabicyclo[2,2,2]octane. However, the catalyst is not necessarily limited thereto, and any catalyst capable of catalyzing a reaction between isocyanate groups and hydroxyl groups may be used without any special restrictions.

In the anti-fouling coating solution according to a disclosed embodiment, a ratio of a molar weight of the fluorinated diol to the fluorine-containing polyurethane polymer (FPU) may be 0.8.

In the anti-fouling coating solution according to a disclosed embodiment, a water contact angle of the fluorine-containing polyurethane polymer (FPU) may range from 143 degrees to 150 degrees. It was confirmed that when a ratio of a molar weight of HFO, which is a chain extender containing a large amount of fluorine groups, to the fluorine-containing polyurethane polymer (FPU) is 0.8 during synthesis of the fluorine-containing polyurethane polymer (FPU), a water contact angle has a maximum value of about 143 degrees.

This may be because as the ratio of the molar weight of HFO increases, a density of fluorine groups within a polymer chain increases, and thus, more fluorine groups are oriented toward an air layer during coating. However, in a case where the ratio of the molar weight of the fluorinated diol to the fluorine-containing polyurethane polymer (FPU) exceeds 0.8, peeling may occur after coating due to poor adhesion to a substrate, and thereafter, the water contact angle may tend to decrease.

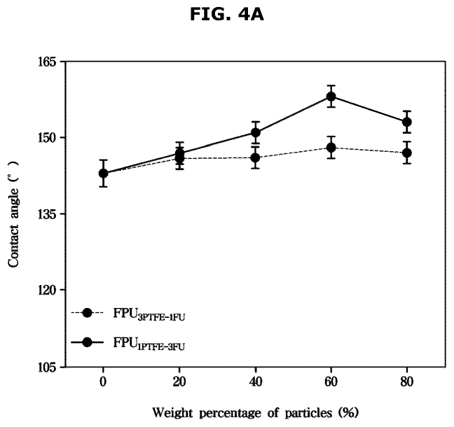

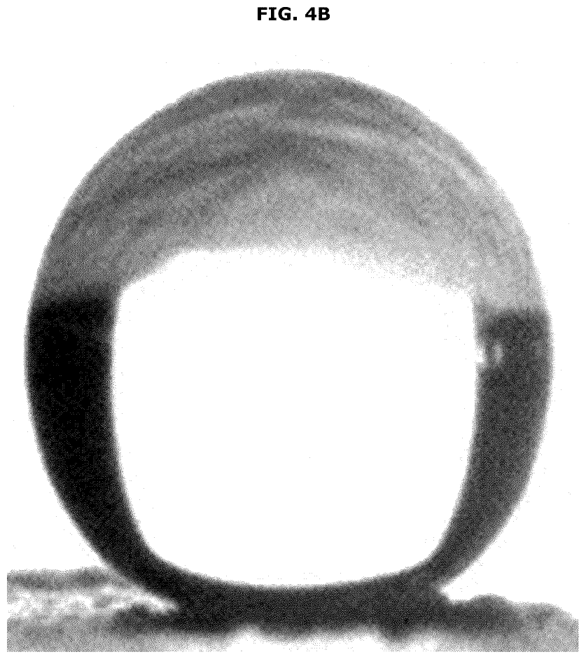

In the anti-fouling coating solution according to a disclosed embodiment, a weight ratio of the fluorine-containing urethane monomer (FU) and the polytetrafluoroethylene (PTFE) may be 3:1. It was confirmed that a case where a ratio of PTFE and FU in the fluorine-containing polyurethane polymer (FPU) with a molar weight ratio of HFO optimized to 0.8 satisfies 1:3 achieves a more improved water contact angle than a case where a ratio of PTFE and FU is 3:1, as shown in FIG. 4A showing optimization of a water contact angle based on weights of particles.

In the anti-fouling coating solution according to a disclosed embodiment, a ratio of a weight sum of the fluorine-containing urethane monomer (FU) and the polytetrafluoroethylene (PTFE) to the fluorine-containing polyurethane polymer (FPU) may range from 40 wt % to 80 wt %.

The anti-fouling coating solution according to a disclosed embodiment may have a water contact angle of 150 degrees to 160 degrees. As a result of measuring a water contact angle while increasing a weight ratio of PTFE and FU when the ratio 1:3 of PTFE and FU in the fluorine-containing polyurethane polymer (FPU) with the molar weight ratio of HFO optimized to 0.8 is satisfied, it was confirmed that when a ratio of a weight sum of the fluorine-containing urethane monomer (FU) and the polytetrafluoroethylene (PTFE) to the fluorine-containing polyurethane polymer (FPU) is between 40 wt % and 80 wt %, super-hydrophobic properties of 150 degrees appear.

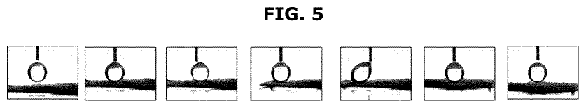

Particularly, in a case where a ratio of a weight sum of the fluorine-containing urethane monomer (FU) and the polytetrafluoroethylene (PTFE) to the fluorine-containing polyurethane polymer (FPU) is 60 wt %, a greatest contact angle of about 158 degrees was obtained and a contact area between water and a part where the anti-fouling coating solution is applied was minimized, as confirmed from FIG. 4B showing a contact surface with water after the coating solution according to the present disclosure is coated on a surface of a device. In addition, water-repellent properties that repel water not only in a process of bringing into contact with water but also in a process of causing friction with water droplets were confirmed as shown in FIG. 5. This means that not only one part shows super-hydrophobic properties but an entire coated area secures super-hydrophobic properties.

However, in a case where a ratio of a weight sum of the fluorine-containing urethane monomer (FU) and the polytetrafluoroethylene (PTFE) to the fluorine-containing polyurethane polymer (FPU) is less than 40 wt %, a water contact angle did not reach 150 degrees, and therefore, super-hydrophobic properties were not secured, and in a case where the ratio exceeds 80 wt %, viscosity increased, which makes it unsuitable for use as a coating solution. Therefore, a ratio of a weight sum of the fluorine-containing urethane monomer (FU) and the polytetrafluoroethylene (PTFE) to the fluorine-containing polyurethane polymer (FPU) may be preferably between 40 wt % and 80 wt %. More preferably, a ratio of a weight sum of the fluorine-containing urethane monomer (FU) and the polytetrafluoroethylene (PTFE) to the fluorine-containing polyurethane polymer (FPU) may be 60 wt %.

So far, the anti-fouling coating solution has been described.

Hereinafter, a coating method using the anti-fouling coating solution will be described.

The coating method using the anti-fouling coating solution according to a disclosed embodiment may include operation of coating the anti-fouling coating solution on a product and drying the product at a temperature of 10° C. to 50° C. for 1 hour to 48 hours. Here, the product may be a material for any object requiring anti-fouling, water-repellent, or anti-bacterial properties. Preferably, the product may be an aluminum material, but is not necessarily limited thereto.

Hereinafter, a method of manufacturing the anti-fouling coating solution will be described in detail.

The method of manufacturing the anti-fouling coating solution may include operations of: producing a fluorine-containing polyurethane polymer (FPU); producing a fluorine-containing urethane monomer (FU); and adding the fluorine-containing urethane monomer (FU) and polytetrafluoroethylene (PTFE) satisfying a weight ratio of 3:1 to the fluorine-containing polyurethane polymer (FPU) and performing stirring, wherein operation of producing the fluorine-containing polyurethane polymer (FPU) may include operations of: producing a first solution by stirring a volatile solvent, a fluorinated alcohol represented by CₐH₂F₂ₐ₋₁OH (with a being a natural number of 10 or less) and having a hydroxyl group bonded to an end, a fluorinated diol represented by C_{b}H₄F_{2b-4}(OH)₂ (with b being a natural number of 20 or less) and having hydroxyl groups respectively bonded to both ends, an alcohol containing two or more hydroxyl groups, an isocyanate crosslinking agent including two or more isocyanate groups, and a catalyst; producing a second solution by adding a volatile solvent and an isocyanate crosslinking agent containing two or more isocyanate groups; producing a third solution by adding the second solution to the first solution and stirring the solution at a temperature of 0° C. to 80° C. for 2 hours to 4 hours; producing a fourth solution by stirring a volatile solvent and a fluorinated alcohol represented by CₐH₂F₂ₐ₋₁OH (with a being a natural number of 10 or less) and having a hydroxyl group bonded to an end; and adding the fourth solution to the third solution and stirring the solution at a temperature of 50° C. to 80° C. for 20 hours to 46 hours, operation of producing the fluorine-containing urethane monomer (FU) may include operation of pulverizing particles formed by stirring an isocyanate crosslinking agent including two or more isocyanate groups and a fluorinated alcohol represented by C_{c}H₂F_{2c-1}OH (with c being a natural number of 10 or less) and having a hydroxyl group bonded to one end for 30 minutes to 2 hours. Here, when the range of the temperature of 50° C. to 80° C. for 20 hours to 46 hours deviates in operation of adding the fourth solution to the third solution and stirring the solution, a hardening degree, mechanical properties, and water-repellent properties of the coating may be reduced. Therefore, it may be preferable that operation of adding the fourth solution to the third solution and stirring the solution is performed at the temperature of 50° C. to 80° C. for 20 hours to 46 hours.

In addition, because the fluorinated alcohol, the fluorinated diol, the isocyanate crosslinking agent, and the catalyst have good solubility when the fluorinated alcohol, the fluorinated diol, the isocyanate crosslinking agent, and the catalyst are stirred with a volatile solvent such as acetone, stirring may be performed using hands, a vial, or vortexing, but is not necessarily limited to these methods.

When the fluorine-containing urethane monomer (FU) is produced, a process of performing stirring for 30 minutes to 2 hours to form a white solid and then pulverizing the white solid into fine particles using a grinding device such as a bowl may be performed. Because operation of producing the fluorine-containing urethane monomer (FU) is a process of producing a solid monomer by mixing two liquid monomers, the operation may be a process of artificially pulverizing, in a mortar, etc., a white solid solidified from two transparent liquids mixed and completely reacted in a reactor, the white solid having the same volume as the liquids, in order to add an appropriate composition ratio of the white solid in the fluorine-containing polyurethane polymer (FPU).

So far, the method of manufacturing the anti-fouling coating solution has been described.

Hereinafter, a manufacturing example and experimental example of the antifouling coating solution will be described in detail.

### <Preparation for Test>

2,2,3,3,4,4,4-Heptafluoro-1-butanol (HF, >98%), 1H,1H,10H,10H-Hexadecafluoro-1,10-decanediol (HFO, >97.0%), Hexamethylene diisocyanate (HDI, >98%), and Dibutyltin dilaurate (DBTDL, >95%) were purchased from TCI, Acetone (>99.7%) was purchased from Samchun Chemicals, Poly(tetrahydrofuran) (PTHF, >97.0%) was purchased from Sigma-Aldrich, and PTFE (99.9%, 260 nm) was purchased from Nanografi, and used as received.

### Manufacturing Example 1

### Producing Fluorine-Containing Polyurethane Polymer (FPU):

PTHF (0.05 mmol), HFO (0.25 mmol), and HF (5.7 mmol) were added to acetone (1 mL) in vial 1 and mixed well. A magnetic stirrer bar, acetone (9 mL), HDI (3.3 mmol), and DBTDL (3 mol %) were added sequentially into a round flask, and a solution in vial 1 was added slowly while stirring. The flask was sealed and stirring was performed at 70° C. for 4 hours. Then, acetone (5 mL) and HF (0.3 mmol) were added to vial 2, mixed well, and slowly put into the flask. Then, stirring was further performed for 20 hours and the reaction was completed to collect a solution.

### Producing Fluorine-Containing Urethane Monomer (FU):

HDI (6.24 mmol) and DBTDL (3 mol %) were added sequentially to vial 3, HF (12.48 mmol) was added while stirring, and stirring was performed for 1 hour until a white solid was formed. After the reaction was completed, pulverization was performed using a bowl to obtain fine particles.

### Preparation and Coating of Super-Hydrophobic Coating Solution:

FU and PTFE were added at a weight ratio of FU:PTFE=3:1 to the synthesized FPU solution (where FU+PTFE account for 60 wt % of the total solution) and mixed well. Then, ultrasonication was performed for approximately 30 minutes to ensure uniform dispersion. The solution was then applied to an aluminum (Al) substrate and thoroughly dried at a room temperature for 24 hours.

### Manufacturing Example 2

### Producing Fluorine-Containing Polyurethane Polymer (FPU):

Polylactide diol (0.05 mmol), 2,2,3,3,4,4-Hexafluoro-1,5-pentandiol (0.25 mmol), and 2,2,3,3,4,4,5,5-Octafluoro-1-pentanol (5.7 mmol) were added to acetone (1 mL) in vial 1 and mixed well. A magnetic stirrer bar, acetone (9 mL), HDI (3.3 mmol), and DBTDL (3 mol %) were added sequentially to a round flask, and a solution in vial 1 was added slowly while stirring. The flask was sealed and stirring was performed at 70° C. for 4 hours. Then, acetone (5 mL) and HF (0.3 mmol) were added to vial 2, mixed well, and slowly put to the flask. Then, stirring was further performed for 20 hours and the reaction was completed to collect a solution.

### Producing Fluorine-Containing Urethane Monomer (FU):

HDI (6.24 mmol) and DBTDL (3 mol %) were added sequentially to vial 3. Then, 2,2,3,3,4,4,5,5-Octafluoro-1-pentanol (12.48 mmol) was added while stirring and stirring was performed for 1 hour until a white solid was formed. After the reaction was completed, pulverization was performed using a bowl to obtain fine particles.

### Preparation and Coating of Super-Hydrophobic Coating Solution:

FU and PTFE were added at a weight ratio of FU:PTFE=3:1 to the synthesized FPU solution (FU+PTFE account for 60 wt % of the total solution) and mixed well. Then, ultrasonication was performed for approximately 30 minutes to ensure uniform dispersion. The solution was then applied to an Al substrate and thoroughly dried at a room temperature for 24 hours.

### {Experimental Example 1}: Checking Synthesis of FPU Through FT-IR

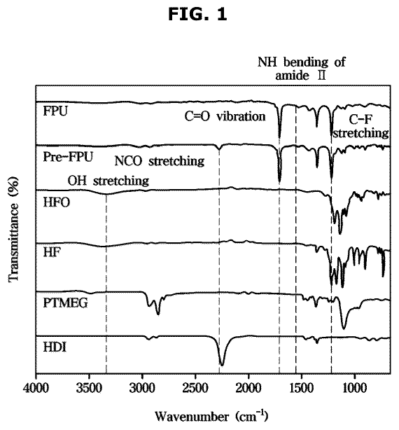

In FIG. 1 showing FT-IR of FPU, through disappearance of a residual NCO peak in FPU and Pre-FPU, it was confirmed that FPU was normally synthesized.

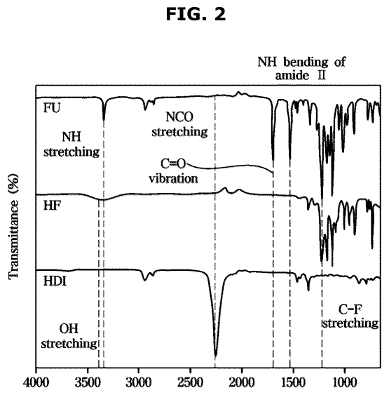

In addition, in FIG. 2 showing FT-IR of FU, through disappearance of a NCO peak in FU, it was confirmed that FU was normally synthesized.

### {Experimental Example 2}: Water Contact Angle Test

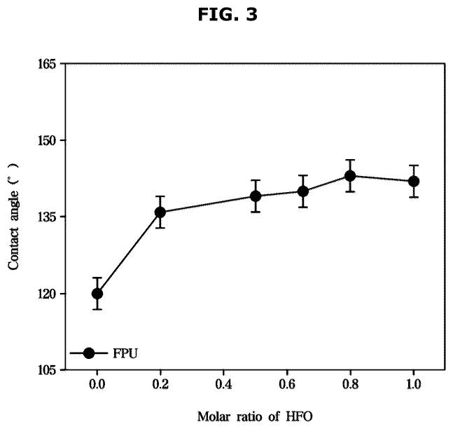

During synthesis of FPU, optimization of a contact angle was performed according to a composition of HFO which is a chain extender containing a large amount of fluorine groups. In the case of the sample, a water contact angle generally tended to increase as a molar ratio of HFO increased, and when a molar ratio of HFO satisfies 0.8, a maximum water contact angle of about 143 degrees was measured, as shown in FIG. 3. In addition, it was confirmed that as the molar ratio of HFO increases, density of fluorine groups within the polymer chain increases, and thus the number of fluorine groups oriented toward an air layer during coating increases, thereby improving the water contact angle. However, it was confirmed that when the molar ratio of HFO exceeds 0.8, adhesive strength with a substrate decreases, resulting in peeling after coating.

In addition, as a result of measuring a water contact angle while maintaining a ratio 1:3 of PTFE and FU in the secured optimal FPU composition and increasing wt % of FPU, super-hydrophobic properties of about 158 degrees appeared at 60 wt %, as confirmed from FIG. 4A showing optimization of the water contact angle according to weights of particles. In this condition, a contact area between water and a coating surface was minimized, as confirmed from FIG. 4B showing a contact surface with water after the coating solution according to the present disclosure is coated on the surface of the device.

In addition, through a water contact and friction test, it was confirmed that the super-hydrophobic properties are maintained over an entire coating area rather than at one area on a surface, as shown in FIG. 5.

### {Experimental Example 3}: Analysis of Microstructure Through SEM

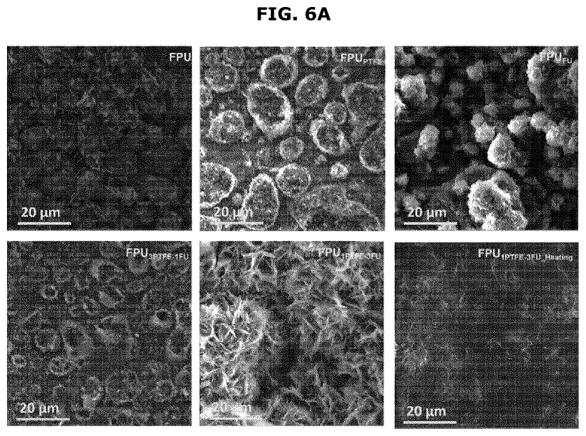

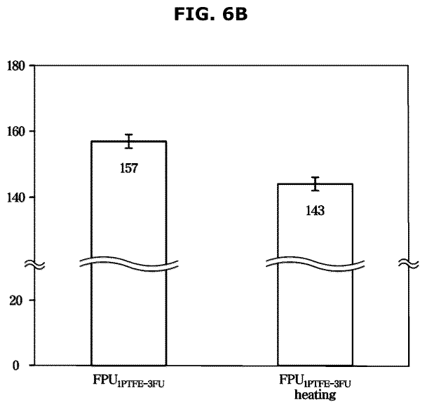

Based on an analysis result of a microstructure through SEM to analyze a cause of super-hydrophobic properties of FPU_{1PTFE-3FU}, it was confirmed that a surface morphology like a coral reef oriented toward an atmosphere appears at a ratio of PTFE:FU=1:3 in FPU, as shown in FIG. 6A. This may be a morphology that occurs because the fluorine group has a property of being oriented toward an air interface after coating due to low surface energy, and in the case of acetone, which is a solvent used in the present disclosure, PTFE as commercial particles does not dissolve in acetone, whereas the fluorine-containing urethane monomer (FU) dissolves in acetone and, when the urethane monomer (FU) is dissolved in acetone and applied to the coating, the urethane monomer (FU) affects a vaporization speed of acetone, excluding the applied solid content. In addition, it was confirmed that when PTFE and fluorine-containing urethane monomer (FU) are mixed at a ratio of 1:3 with the fluorine-containing polyurethane polymer (FPU) developed under the condition of 60 wt % FPU, a vaporization speed of acetone at a room temperature in the composition is optimized to most suitably orient the fluorine groups contained in the composition toward the air interface and thus the fluorine groups are oriented in the shape of a coral reef, as shown in a SEM image of FIG. 6A

To prove this, it was confirmed that when FPU_{3PTFE-1FU} is dried at a high temperature of 70 degrees instead of a room temperature, a surface morphology like a coral reef is not formed, as shown in a second row and third column of FIG. 6A. In addition, it was confirmed that when FPU_{3PTFE-1FU} is dried at the high temperature of 70 degrees instead of the room temperature, the contact angle decreases from 157 degrees to 143 degrees, as shown in FIG. 6B.

### {Experimental Example 4}: Checking Mechanical Strength

ASTM D3359-17 standard does not have a standard for adhesive strength of a tape and recommends a force of 634 Nm⁻¹ to 700 Nm⁻¹ (steel value). However, based on a result of using the 3M VHB test (2,600 Nm⁻¹), it was confirmed that a water contact angle is maintained at 150 degrees or more up to 10 times, as shown in FIG. 7A. In addition, based on the result of using the 3M VHB test (2,600 Nm⁻¹), it was confirmed that a surface morphology like a coral reef on the surface of the coating material is maintained up to 10 times and thus there is no significant effect on the super-hydrophobic properties, as shown in FIG. 7B.

### {Experimental Example 5}: Antifouling and Self-Cleaning Test

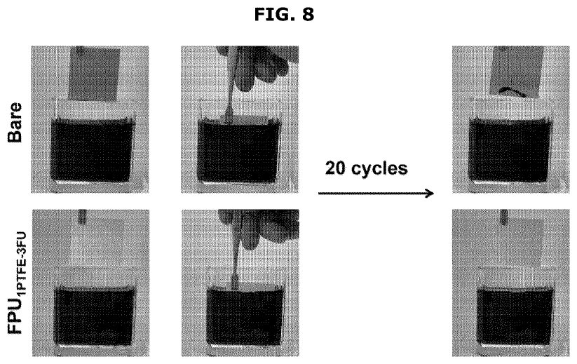

According to a result of performing an anti-fouling test using methylene blue as a contaminant based on the super-hydrophobic properties of FPU_{1PTFE-3FU}, it was confirmed that, unlike the bare substrate on which methylene blue remains 20 times or more after the substrate is immersed in methylene blue 20 times or more, the substrate coated with the coating solution according to the present disclosure shows relatively excellent anti-fouling properties because the contaminant flows off and no contaminant remains after the substrate is immersed in methylene blue about 20 times or more, as shown in FIG. 8.

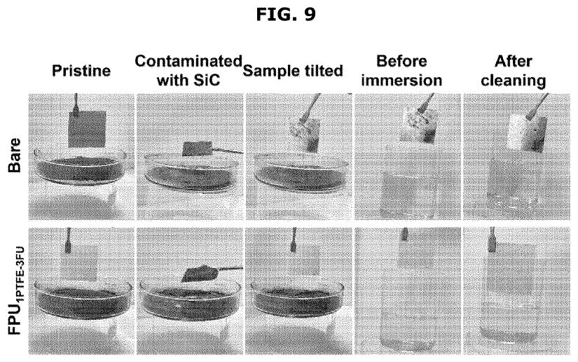

In addition, based on a result of performing a self-cleaning test using SiC of dust series, it was confirmed that SiC remains when the bare substrate is immersed in SiC and tilted, and even when the substrate was immersed in water, SiC remains, as shown in FIG. 9.

In contrast, when the anti-fouling coating according to the present disclosure was applied to a substrate, it was confirmed that SiC is removed simply by tilting the substrate after immersing the substrate in SiC, and when the anti-fouling coating substrate is immersed in water, SiC is completely removed, as shown in FIG. 9, which shows relatively excellent self-cleaning ability.

### {Experimental Example 6}: Biological Anti-Fouling (Bio-Fouling) Test

(a) Staphylococcus aureus or Streptococcus mutans was cultured in tryptic soy broth and brain heart infusion broth, respectively, at 37° C. for 24 hours, and then the strains were spread on an agar medium. The spread medium was further cultured at 37° C. for 24 hours, and a strain isolated from a single colony among colonies formed was cultured again on a new medium at 37° C. for 24 hours.

A bacterial culture suspension obtained was diluted to show a 600 nm wavelength absorbance of 0.4 and then applied to a super-hydrophobic material and a bare substrate. After culturing at 37° C. for 24 hours, the super-hydrophobic material and bare substrate coated with bacteria were washed once with a phosphate buffered saline solution and then cultured at 25° C. for 12 hours in a phosphate buffered saline solution containing 2.5 vol % glutaraldehyde to fix the applied bacteria.

After washing was performed once with phosphate buffered saline and once more with deionized water, a dehydration process was performed by immersing in a 50-95 vol % ethanol aqueous solution. Then, after the substrate was dried in a vacuum oven at 25° C. for 18 hours, the substrate was placed on an SEM stub, sputtered with Pt to produce an SEM specimen, and observed under an SEM. Antibacterial performance was compared by counting the number of bacteria attached per unit area.

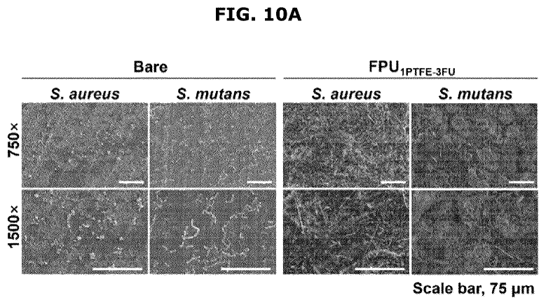

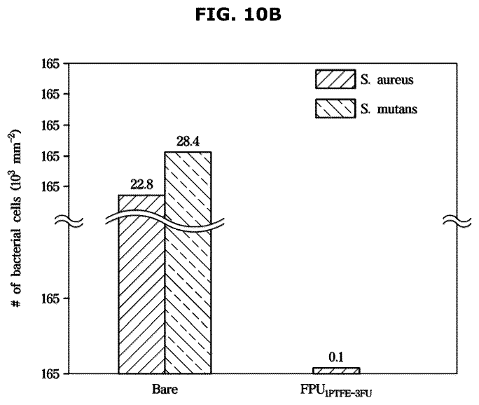

Based on a result of conducting the anti-fouling test using bacteria as described above, it was confirmed that in the case of bare (Al substrate), S. aureus of about 22.8 and S. mutans of about 28.4 were fixed per unit area (103 mm) on the surface, whereas in the case of FPU_{1PTFE-3FU}, S. aureus of about 0.1 and S. mutans of 0.1 were fixed per unit area (103 mm) on the surface, and S. mutans was not detected, indicating that bacterial contamination was significantly low, as shown in FIGS. 10A and 10B.

An anti-fouling coating solution according to an embodiment may include: a fluorine-containing polyurethane polymer (FPU), a fluorine-containing urethane monomer (FU), and polytetrafluoroethylene (PTFE), wherein the fluorine-containing polyurethane polymer (FPU) may include: a volatile solvent; a fluorinated alcohol represented by CₐH₂F₂ₐ₋₁OH (with a being a natural number of 10 or less) and having a hydroxyl group bonded to an end; a fluorinated diol represented by C_{b}H₄F_{2b-4}(OH)₂ (with b being a natural number of 20 or less) and having hydroxyl groups respectively bonded to both ends; an alcohol containing two or more hydroxyl groups; and an isocyanate crosslinking agent containing two or more isocyanate groups, a ratio of a molar weight of the fluorinated diol to the fluorine-containing polyurethane polymer (FPU) may range from 0.7 to 0.9, a ratio of a sum of the number of hydroxyl groups contained in the fluorinated alcohol, the fluorinated diol, and the alcohol to the number of isocyanate groups contained in the isocyanate crosslinking agent may be 1:1, and the fluorine-containing urethane monomer (FU) may include: a fluorinated alcohol represented by C_{c}H₂F_{2c-1}OH (with c being a natural number of 10 or less) and having a hydroxyl group bonded to an end; and an isocyanate crosslinking agent containing two or more isocyanate groups. Therefore, a polyurethane-based coating material and a coating solution including the same, which are capable of securing mechanical strength based on a polyurethane material and inducing super-hydrophobic properties to implement anti-fouling and antibacterial properties, may be provided.

In the anti-fouling coating solution, the volatile solvent may include acetone.

In the anti-fouling coating solution, a of the fluorinated alcohol contained in the fluorine-containing polyurethane polymer (FPU) may be 4, b of the fluorinated diol may be 10, and c of the fluorinated alcohol contained in the fluorine-containing urethane monomer (FU) may be 4.

In the anti-fouling coating solution, the alcohol containing two or more hydroxyl groups may be one or more selected from a group including poly(tetrahydrofuran) (PTHF), polycaprolactone diol, poly(hydroxybutyrate) diol, poly(lactide-co-caprolactone) diol, poly(ethylene glycol) diol, poly(ethylene terephthalate) diol, fatty acid-based linear diol, polylactide diol, poly(butylene glycol) diol, poly(propylene oxide) diol, poly(tetramethylene oxide) diol, poly(ethylene adipate) diol, castor oil-based diol, polyglycolide diol, poly(lactide-b-glycolide) diol, poly(hexamethylene carbonate) diol, polycarbonate diol, poly(buthylene adipate) diol, and soybean oil-based diol.

In the anti-fouling coating solution, the isocyanate crosslinking agent may be one or more selected from a group including hexamethylene diisocyanate (HIDI), diphenylmethane 4,4′-diisocyanate, 1,3-phenylene diisocyanate, isophorone diisocyanate, polyhexamethylene diisocyanate, triphenylmethan-4,4′,4″-triisocyanate, 1,3,5-triisocyanato-2-methylbenzene, and 1,3,5-triisocyanato-2,4,6-trimethylbenzene.

In the anti-fouling coating solution, the fluorine-containing polyurethane polymer (FPU) and the fluorine-containing urethane monomer (FU) may further include one or more catalysts selected from among dibutyltin dilaurate (DBTDL), dimethylaminopyridine (DMAP), triethylamine (TEA), diazabicyclo[2,2,2]octane, or 1,4-diazabicyclo[2,2,2]octane.

In the anti-fouling coating solution, a water contact angle of the fluorine-containing polyurethane polymer (FPU) may range from 140 degrees to 150 degrees.

In the anti-fouling coating solution, a molar weight ratio of the fluorinated diol to the fluorine-containing polyurethane polymer (FPU) may be 0.8.

In the anti-fouling coating solution, a water contact angle of the fluorine-containing polyurethane polymer (FPU) may range from 143 degrees to 150 degrees.

In the anti-fouling coating solution, a weight ratio of the fluorine-containing urethane monomer (FU) and the polytetrafluoroethylene (PTFE) may be 3:1.

In the anti-fouling coating solution, a ratio of a weight sum of the fluorine-containing urethane monomer (FU) and the polytetrafluoroethylene (PTFE) to the fluorine-containing polyurethane polymer (FPU) may range from 40 wt % to 80 wt %.

A water contact angle of the anti-fouling coating solution may range from 150 degrees to 160 degrees.

In the anti-fouling coating solution, a ratio of a weight sum of the polyfluorine-containing urethane monomer (FU) and the polytetrafluoroethylene (PTFE) to the fluorine-containing polyurethane polymer (FPU) may be 60 wt %.

A water contact angle of the anti-fouling coating solution may range from 157 degrees to 160 degrees.

A method of manufacturing an anti-fouling coating solution according to an embodiment may include: producing a fluorine-containing polyurethane polymer (FPU); producing a fluorine-containing urethane monomer (FU); and adding the fluorine-containing urethane monomer (FU) and polytetrafluoroethylene (PTFE) satisfying a weight ratio of 3:1 to the fluorine-containing polyurethane polymer (FPU) and performing stirring, wherein the producing of the fluorine-containing polyurethane polymer (FPU) may include: producing a first solution by stirring a volatile solvent, a fluorinated alcohol represented by CₐH₂F₂ₐ₋₁OH (with a being a natural number of 10 or less) and having a hydroxyl group bonded to an end, a fluorinated diol represented by C_{b}H₄F_{2b-4}(OH)₂ (with b being a natural number of 20 or less) and having hydroxyl groups respectively bonded to both ends, an alcohol containing two or more hydroxyl groups, an isocyanate crosslinking agent including two or more isocyanate groups, and a catalyst; producing a second solution by adding a volatile solvent and an isocyanate crosslinking agent containing two or more isocyanate groups; producing a third solution by adding the second solution to the first solution and stirring at a temperature of 0° C. to 80° C. for 2 hours to 4 hours; producing a fourth solution by stirring a volatile solvent and a fluorinated alcohol represented by CₐH₂F₂ₐ₋₁OH (with a being a natural number of 10 or less) and having a hydroxyl group bonded to an end; and adding the fourth solution to the third solution and stirring at a temperature of 50° C. to 80° C. for 20 hours to 46 hours, and the producing of the fluorine-containing urethane monomer (FU) may include pulverizing particles formed by stirring an isocyanate crosslinking agent including two or more isocyanate groups and a fluorinated alcohol represented by C_{c}H₂F_{2c-1}OH (with c being a natural number of 10 or less) and having a hydroxyl group bonded to one end for 30 minutes to 2 hours.

In the method of manufacturing the anti-fouling coating solution, the volatile solvent may include acetone.

In the method of manufacturing the anti-fouling coating solution, a of the fluorinated alcohol contained in the fluorine-containing polyurethane polymer (FPU) may be 4, b of the fluorinated diol may be 10, a ratio of a sum of the number of hydroxyl groups contained in the fluorinated alcohol, the fluorinated diol, and the alcohol contained in the fluorine-containing polyurethane polymer (FPU) to the number of isocyanate groups contained in the isocyanate crosslinking agent may be 1:1, and c of the fluorinated alcohol contained in the fluorine-containing urethane monomer (FU) may be 4.

In the method of manufacturing the anti-fouling coating solution, a molar weight ratio of the fluorinated diol to the fluorine-containing polyurethane polymer (FPU) may be 0.8.

In the method of manufacturing the anti-fouling coating solution, a ratio of a weight sum of the polyfluorine-containing urethane monomer (FU) and the polytetrafluoroethylene (PTFE) to the fluorine-containing polyurethane polymer (FPU) may be 60 wt %.

In the method of manufacturing the anti-fouling coating solution, the alcohol containing two or more hydroxyl groups may be one or more selected from a group including poly(tetrahydrofuran) (PTHF), polycaprolactone diol, poly(hydroxybutyrate) diol, poly(lactide-co-caprolactone) diol, poly(ethylene glycol) diol, poly(ethylene terephthalate) diol, fatty acid-based linear diol, polylactide diol, poly(butylene glycol) diol, poly(propylene oxide) diol, poly(tetramethylene oxide) diol, poly(ethylene adipate) diol, castor oil-based diol, polyglycolide diol, poly(lactide-b-glycolide) diol, poly(hexamethylene carbonate) diol, polycarbonate diol, poly(buthylene adipate) diol, and soybean oil-based diol, the isocyanate crosslinking agent may be one or more selected from a group including hexamethylene diisocyanate (HIDI), diphenylmethane 4,4′-diisocyanate, 1,3-phenylene diisocyanate, isophorone diisocyanate, polyhexamethylene diisocyanate, triphenylmethan-4,4′,4″-triisocyanate, 1,3,5-triisocyanato-2-methylbenzene, and 1,3,5-triisocyanato-2,4,6-trimethylbenzene, and the fluorine-containing polyurethane polymer (FPU) and the fluorine-containing urethane monomer (FU) may further include one or more catalysts selected from among dibutyltin dilaurate (DBTDL), dimethylaminopyridine (DMAP), triethylamine (TEA), diazabicyclo[2,2,2]octane, or 1,4-diazabicyclo[2,2,2]octane.

So far, an anti-fouling coating solution and a method of manufacturing the anti-fouling coating solution have been described.

According to a concept of the present disclosure, a polyurethane-based coating material and a coating solution including the same, which are capable of securing mechanical strength based on a polyurethane-based material and inducing super-hydrophobic properties to implement anti-fouling and antibacterial properties, may be provided.

Effects that may be achieved by the present disclosure are not limited to the above-mentioned effects, and other effects not mentioned will be clearly understood by one of ordinary skill in the technical field to which the present disclosure belongs from the following descriptions.

So far, the embodiments of the present disclosure have been described, however, the present disclosure is not limited to the above-described specific embodiments. It should be interpreted that various modifications may be made by one of ordinary skill in the technical art to which the disclosure belongs, without deviating from the gist claimed in the following claims.

1. An anti-fouling coating solution comprising:
a fluorine-containing polyurethane polymer (FPU), a fluorine-containing urethane monomer (FU), and polytetrafluoroethylene (PTFE),
wherein the FPU includes:
a volatile solvent,
a fluorinated alcohol represented by CₐH₂F₂ₐ₋₁OH (with a being a natural number of 10 or less) and containing a hydroxyl group bonded to an end,
a fluorinated diol represented by C_{b}H₄F_{2b-4}(OH)₂ (with b being a natural number of 20 or less) and containing hydroxyl groups respectively bonded to both ends,
an alcohol containing two or more hydroxyl groups, and
a first isocyanate crosslinking agent containing two or more isocyanate groups,
a ratio of a molar weight of the fluorinated diol of the FPU to a molar weight of the FPU ranges from 0.7 to 0.9,
a sum of a number of hydroxyl groups contained in the fluorinated alcohol of the FPU, a number of hydroxyl groups contained in the fluorinated diol of the FPU, and a number of hydroxyl groups contained in the alcohol of the FPU is equal to a number of the two or more isocyanate groups contained in the first isocyanate crosslinking agent, and
the FU includes:
a fluorinated alcohol represented by C_{c}H₂F_{2c-1}OH (with c being a natural number of 10 or less) and having a hydroxyl group bonded to an end, and
a second isocyanate crosslinking agent containing two or more isocyanate groups.

2. The anti-fouling coating solution of claim 1, wherein
the volatile solvent includes acetone.

3. The anti-fouling coating solution of claim 1, wherein
the a of the fluorinated alcohol contained in the FPU is 4,
the b of the fluorinated diol is 10, and
the c of the fluorinated alcohol of the FU is 4.

4. The anti-fouling coating solution of claim 1, wherein
the alcohol of the FPU includes one or more alcohols selected from a group including poly(tetrahydrofuran) (PTHF), polycaprolactone diol, poly(hydroxybutyrate) diol, poly(lactide-co-caprolactone) diol, poly(ethylene glycol) diol, poly(ethylene terephthalate) diol, fatty acid-based linear diol, polylactide diol, poly(butylene glycol) diol, poly(propylene oxide) diol, poly(tetramethylene oxide) diol, poly(ethylene adipate) diol, castor oil-based diol, polyglycolide diol, poly(lactide-b-glycolide) diol, poly(hexamethylene carbonate) diol, polycarbonate diol, poly(buthylene adipate) diol, and soybean oil-based diol.

5. The anti-fouling coating solution of claim 1, wherein
the first isocyanate crosslinking agent and/or the second isocyanate crosslinking agent includes one or more isocyanates selected from a group including hexamethylene diisocyanate (HIDI), diphenylmethane 4,4′-diisocyanate, 1,3-phenylene diisocyanate, isophorone diisocyanate, polyhexamethylene diisocyanate, triphenylmethan-4,4′,4″-triisocyanate, 1,3,5-triisocyanato-2-methylbenzene, and 1,3,5-triisocyanato-2,4,6-trimethylbenzene.

6. The anti-fouling coating solution of claim 1, wherein
the FPU and the FU further include one or more catalysts selected from a group including dibutyltin dilaurate (DBTDL), dimethylaminopyridine (DMAP), triethylamine (TEA), diazabicyclo[2,2,2]octane, and 1,4-diazabicyclo[2,2,2]octane.

7. The anti-fouling coating solution of claim 3, wherein
the FPU includes a water contact angle of 140 degrees to 150 degrees.

8. The anti-fouling coating solution of claim 3, wherein
the ratio of the molar weight of the fluorinated diol of the FPU to the molar weight of the FPU is 0.8.

9. The anti-fouling coating solution of claim 8, wherein
the FPU includes a water contact angle of 143 degrees to 150 degrees.

10. The anti-fouling coating solution of claim 8, wherein
a weight ratio of the FU to the PTFE is 3:1.

11. The anti-fouling coating solution of claim 10, wherein
a sum of a weight of the FU and a weight of the PTFE is 40% to 80% of a weight of the FPU.

12. The anti-fouling coating solution of claim 11, wherein
the anti-fouling coating solution includes a water contact angle of 150 degrees to 160 degrees.

13. The anti-fouling coating solution of claim 10, wherein
a sum of a weight of the FU and a weight of the PTFE is 60% of a weight of the FPU.

14. The anti-fouling coating solution of claim 13, wherein
the anti-fouling coating solution includes a water contact angle of 157 degrees to 160 degrees.

15. A method of manufacturing an anti-fouling coating solution, comprising:
producing a fluorine-containing polyurethane polymer (FPU) by:
mixing a volatile solvent, a fluorinated alcohol represented by CₐH₂F₂ₐ₋₁OH (with a being a natural number of 10 or less) and containing a hydroxyl group bonded to an end, a fluorinated diol represented by C_{b}H₄F_{2b-4}(OH)₂ (with b being a natural number of 20 or less) and containing hydroxyl groups respectively bonded to both ends, an alcohol containing two or more hydroxyl groups, an isocyanate crosslinking agent including two or more isocyanate groups, and a catalyst to form a first solution,
mixing a volatile solvent and an isocyanate crosslinking agent containing two or more isocyanate groups to form a second solution,
mixing the second solution and the first solution at a temperature of 0° C. to 80° C. for 2 hours to 4 hours to form a third solution,
mixing a volatile solvent and a fluorinated alcohol represented by CₐH₂F₂ₐ₋₁OH (with a being a natural number of 10 or less) and having a hydroxyl group bonded to an end to form a fourth solution, and
mixing the fourth solution and the third solution at a temperature of 50° C. to 80° C. for 20 hours to 46 hours,
producing a fluorine-containing urethane monomer (FU) by:
pulverizing particles formed by stirring an isocyanate crosslinking agent including two or more isocyanate groups and a fluorinated alcohol represented by C_{c}H₂F_{2c-1}OH (with c being a natural number of 10 or less) and having a hydroxyl group bonded to one end for 30 minutes to 2 hours, and
mixing, with the produced FPU, the produced FU and a polytetrafluoroethylene (PTFE) satisfying a weight ratio of 3 of the produced FU to 1 of the PTFE.
